(19) United States
(12) Patent Application Publication
(10) Pub. No.: US 2007/0226347 A1
(43) Pub. Date: Sep. 27, 2007

(54) Method and apparatus for dynamically changing the TCP behavior of a network connection

(76) Inventors: Hsiao-Keng J. Chu, Palo Alto, CA (US); Darrin P. Johnson, Mountain View, CA (US); Ka-Cheong Poon, Kowloon (HK)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/388,429

(22) Filed: Mar. 23, 2006

(51) Int. Cl. G06F 15/16

(52) U.S. Cl. 709/227; 709/228

(57) ABSTRACT

One embodiment of the present invention provides a system that dynamically changes the TCP behavior of a network connection. First, the system receives a request to change the TCP behavior for a network connection that allows communication between a first computer system and a second computer system. In response, the system changes a function associated with the TCP behavior of the network connection to a new function that provides TCP behavior better-tuned to the needs and environment of the network connection.

### RELATED APPLICATION

The subject matter of this application is related to the subject matter in a co-pending non-provisional application by the same inventors as the instant application and filed on the same day as the instant application entitled, “A Plug-In Architecture for a Network Stack in an Operating System,” having serial number TO BE ASSIGNED, and filing date TO BE ASSIGNED (Attorney Docket No. SUN06-0660).

### BACKGROUND

1. Field of the Invention

The present invention generally relates to computer networks. More specifically, the present invention relates to a method for dynamically changing the TCP behavior of a network connection.

2. Related Art

The transmission control protocol (TCP) is part of the core Internet protocol which is used to transfer data between computing devices. The goal of TCP is to transfer data from an application on a computing device through a shared network resource to a second device as quickly, efficiently, and reliably as possible, despite potential contention and congestion.

While the basic operation of TCP has not changed dramatically since the initial publication of the standard in 1981, the protocol has been forced to evolve in response to changing network conditions such as new link types (e.g., wireless networks) and higher bandwidth wired networks. Substantial ongoing research on congestion control and avoidance has resulted in numerous TCP congestion control techniques, such as Reno, New Reno, Vegas, HS-TCP, Fast TCP, S-TCP, and Bic-TCP. However, such congestion control techniques add substantial complexity to TCP and the network stack. Furthermore, end-to-end links can traverse numerous networks with diverse characteristics, and no single congestion control approach encompasses the wide range of modem networks.

Hence, what is needed are architectures and methods that facilitate congestion control for TCP without the limitations of existing approaches.

### SUMMARY

One embodiment of the present invention provides a system that dynamically changes the TCP behavior of a network connection. First, the system receives a request to change the TCP behavior for a network connection that provides communication between a first computer system and a second computer system. In response, the system changes a function associated with the TCP behavior of the network connection to a new function that provides TCP behavior better-tuned to the needs and environment of the network connection.

In a variation on this embodiment, the network stack of the computer system includes a plug-in architecture that allows each network connection on the computer system to use a different function to control TCP behavior, thereby allowing multiple functions for controlling TCP behavior to execute simultaneously on the computer system.

In a further variation, the system associates a function pointer with each network connection. To change the function associated with the TCP behavior for the network connection, the system changes the function pointer to point to a new function.

In a further variation, the system uses a vector of function pointers to track the functions that determine the TCP behavior of every network connection in the computer system.

In a further variation, the request to change the TCP behavior for the network connection is based on:
user input or specification of priority;
application input or preference;
an application type;
system policy;
the source and/or destination port numbers used by the network connection;
the source and/or destination Internet Protocol (IP) addresses of the network connection;
the protocol used by the network connection;
the characteristics of the network connection, including latency, bandwidth, loss-rate, and traffic characteristics;
the service provided by the network connection;
cached path characteristics from past connections;
the location of the computer system and the second computer system; or
any combination of the above.

In a further variation, the system maintains a list of candidate functions for TCP behavior, and allows an application or user to choose the new function from the list.

In a variation on this embodiment, the TCP behavior of the new function does not comply with the TCP standard.

In a further variation, the new function does not implement congestion control. This non-compliant TCP behavior can be used to optimize data transfer between the computer system and the second computer system in some environments.

In a variation on this embodiment, the system changes the function associated with the TCP behavior by first disabling a portion of the network stack to put the network connection into a quiescent state. The system then changes the function pointer to point to the new function. Finally, the system re-enables the portion of the network stack to return the network connection to an active state.

### BRIEF DESCRIPTION OF THE FIGURES

FIG. 1 illustrates two computer systems communicating over a network link in accordance with an embodiment of the present invention.

FIG. 2 illustrates TCP transmit and receive interactions in accordance with an embodiment of the present invention.

FIG. 3 presents a flow chart illustrating the process of changing the TCP behavior of a network connection in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

TCP Congestion Control

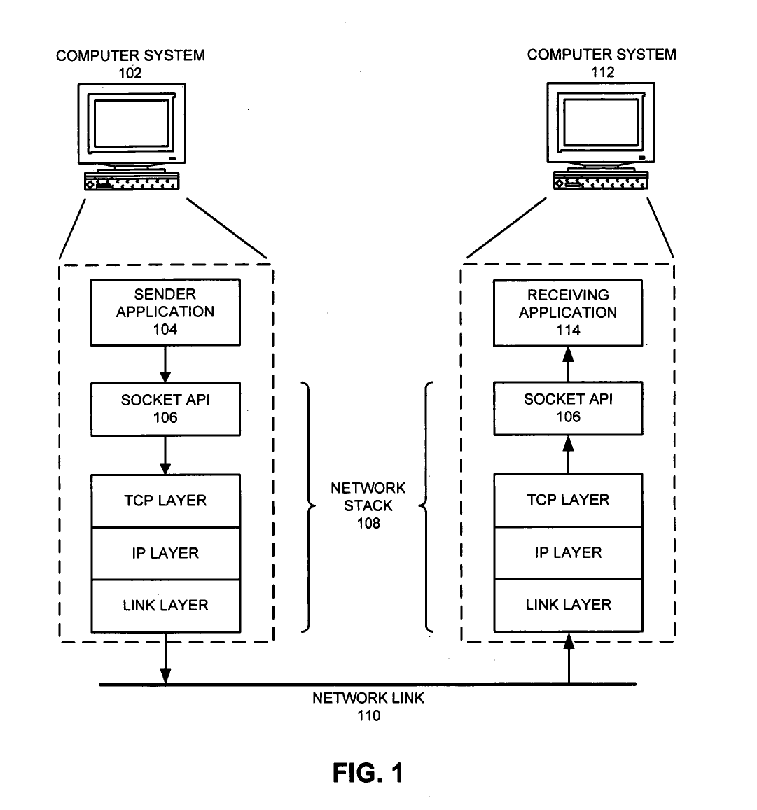

FIG. 1 illustrates two computer systems communicating over a network link 110. A sender application 104 in the sending computer system 102 uses a socket API 106 to pass data to a network stack 108, which packetizes the data and sends it over a network link 110 to a receiving computer system 112. The network stack 108 on the receiving computer system 112 processes the packets and passes them up to the receiving application 114 through the socket API 106.

The TCP layer comprises an important part of the network stack 108. The core of the TCP protocol is based on a set of parameters that together determine a set of data packets, a timeframe in which they will be transmitted from the sender side, and how acknowledgements will be generated on the receiving side. The sending side constantly recalculates the set of parameters based on feedback from, for instance, acknowledgement packets and local timers, in order to decide which data to send or resend, and when. Important parameters include:
“RTT”, the round-trip time it takes a data packet to travel from the sender to the receiver;
“cwnd,” the size of the congestion window, which specifies the number of data packets that can be transmitted without having received corresponding acknowledgement packets; and
“ssthresh,” the slow-start threshold, which determines how the size of the congestion window increases.
   The receiver side, meanwhile, decides when to generate either positive, negative, or selective acknowledgements.

TCP strives to maximize the utilization of the available network bandwidth in a “fair” manner (i.e. friendly to other TCP traffic), while avoiding, or otherwise quickly recovering from, network congestion. Achieving this goal is difficult given the wide diversity of modern networking technologies. The effectiveness of congestion control in artificial and production environments is often sorely tested by factors such as the distance between sender and receiver, window sizes, the number of streams, network configuration, load, varying drop rates, link reliability, etc. While many different TCP techniques have been proposed over the years, including but not limited to Reno, New Reno, Vegas, HS-TCP, S-TCP, Bic-TCP, Cubic, Fast-TCP, and TCP-Westwood, no technique has been found that performs best across all instances.

Traditionally, the congestion-control technique is hard-wired in the TCP implementation, and can only be changed by compiling a second operating system kernel with a new technique, shutting down the system, and replacing the current operating system kernel. Since no single, definitive solution exists nor seems to be forthcoming, a traditional, network-stack architecture with one hard-wired TCP congestion-control technique will not provide a production solution nor keep up with future advances in TCP research and the possible proliferation of TCP techniques.

The present invention extends TCP using a plug-in architecture for the network stack of an operating system.

A Plug-In Architecture for TCP Congestion Control

The present invention extends existing network stacks (including stacks deployed in kernel space, user space, and/or in TCP offload engines) to allow core functions of the TCP congestion control system to be changed easily and dynamically. While many portions of the TCP implementation contribute to TCP dynamics, only a subset of the implementation is likely to still evolve. One such area still seeing significant changes is transmission-side congestion avoidance.

In one embodiment of the present invention, a subset of the TCP transmit functionality becomes a swappable plug-in, while the standardized and unchanging portion of the TCP layer remains hard-wired. The system enters the swappable portion whenever an event is encountered that triggers a re-computation of congestion parameters, for instance cwnd, ssthresh, and RTT. Such triggers for the TCP sender side include:
the receipt of new data to be sent;
the receipt of a positive acknowledgement indicating that a packet was received;
the receipt of negative acknowledgements indicating that packets may have been lost;
the receipt of a selective acknowledgement that identifies a received packet;
the expiration of a timer;
the elapse of a round-trip time interval;
a call-back occurring either before or after a packet transmission or re-transmission; and
the receipt of an explicit congestion notification (ECN).
   The plug-in module includes a set of functions that are invoked in response to the above events. These functions can be given access to fields from the TCP layer, such as the TCP control block and headers of acknowledgement packets, thereby allowing the plug-in to work directly with the raw TCP parameters. Allowing this type of access, instead of creating an abstraction on top of TCP, enables all approaches of congestion avoidance, including loss-based and delay-based approaches. The main output from these functions is a set of recomputed parameters (e.g. cwnd, ssthresh, RTT), which are then fed back into the hard-wired portion of the TCP implementation to continue execution.

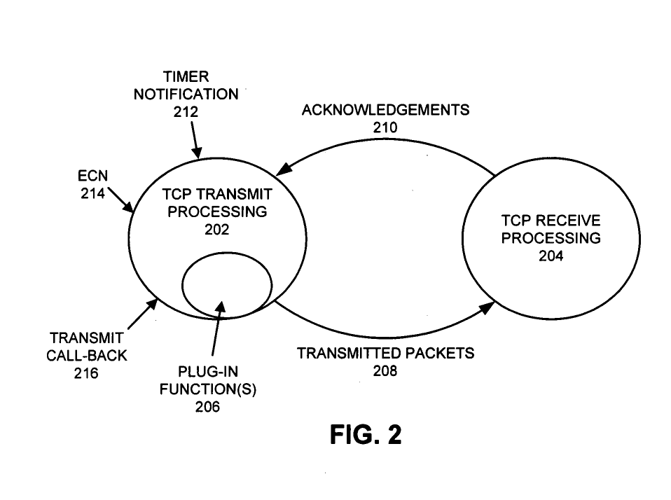

FIG. 2 illustrates typical TCP transmit and receive interactions in the system. In one embodiment of the present invention, the TCP transmit processing system 202 includes a set of plug-in functions 206 which affect the characteristics and timing of the packets transmitted 208 by the sender. The TCP receive processing 204 on the receiving computer system in turn returns positive, negative, or selective acknowledgements 210. The TCP transmit processing 202 takes into account these acknowledgements 210, along with other events such as timer notifications 212, ECNs 214, and transmit call-backs 216 prompted by packet transmissions or re-transmissions.

The plug-in architecture allows the system to switch between different congestion avoidance techniques. Each technique uses a different approach, and may therefore maintain a different set of internal state. For instance, a delay-based technique such as Fast-TCP may track average queuing delay as well as minimum and biased RTTs, while TCP-Westwood gleans data from successive acknowledgement packets to compute an eligible rate estimate (ERE). Alternatively, High-Speed TCP (HS-TCP), a loss-based technique, keeps an internal table of congestion window sizes (i.e. a table for “a (.cwnd)” and “b (cwnd)”). These internal parameters are typically not visible outside the plug-in, but can be used by the plug-in to adjust key parameters that control TCP behavior. The system can effectively give full control of TCP behavior to the plug-in by only allowing control parameters to be changed in the plugged-in functions.

In general, given the changin nature (e.g. increasing bandwidth, distances, topology variations, production requirements, etc) of production and experimental networks, allowing TCP behavior to be easily replaced provides significant advantages over the previous hard-wired approach, which provides only limited capability. Allowing the TCP behavior to be easily modified, either manually or dynamically, provides an opportunity to tune network performance of production networks as well as provide a flexible way to explore, implement, and test new congestion control techniques.

In one embodiment of the present invention, the plug-in functionality is implemented using a dynamically-loaded kernel module that can be loaded or unloaded both at system boot-time as well as when the system is active.

Per-Connection TCP Congestion Control

While a plug-in architecture for TCP allows TCP behavior to be changed at the system level, each network connection may encounter different conditions based on the destination or other factors, so a more ideal solution allows multiple techniques to be applied simultaneously on the computer system.

One embodiment of the present invention provides network resource- and bandwidth-control by extending the plug-in architecture to allow different TCP behaviors to be plugged-in on a per-connection basis. The system maintains a vector of function pointers that point to the chosen TCP technique for each connection. Depending on system policy, the appropriate technique for a connection may be chosen at a very fine granularity, and vary dynamically, based on:
user input or specification of priority;
application input or preference;
an application type;
system policy;
the source and/or destination port numbers used by the network connection;
the source and/or destination Internet Protocol (IP) addresses of the network connection;
the protocol used by the network connection;
the characteristics of the network connection, including latency, bandwidth, loss-rate, and traffic characteristics;
the service provided by the network connection;
cached path characteristics from past connections;
the location of the computer system and the second computer system; or
any combination of the above.
   For instance, a connection to a local wireless IP address may need different TCP behavior than a streaming video application on a fixed network transferring real-time video from a remote server. The system can maintain a list of candidate functions for TCP behavior from which the application or user chooses, or in a further embodiment, privileged users can define and plug-in their own functions, subject to a control policy that deters abusive network behavior.

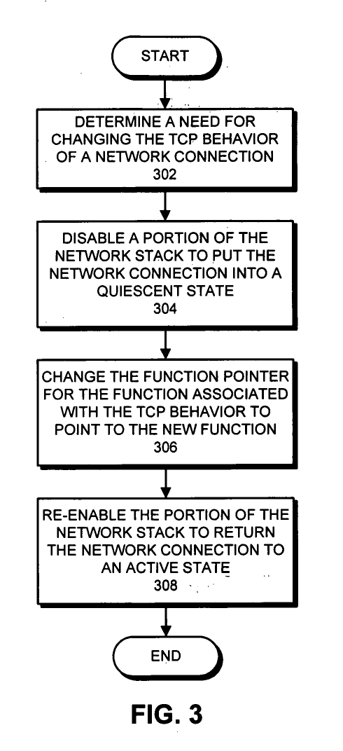

FIG. 3 presents a flow chart illustrating the process of changing the TCP behavior of a network connection. The system first determines or is notified of a need for changing the TCP behavior of a network connection (step 302). In response, the system disables a relevant portion of the network stack in order to put the network connection into a quiescent state (step 304). Then, the system changes the function pointer for the function associated with the TCP behavior to point to a new function with the desired behavior (step 306). Finally, the system re-enables the corresponding portion of the, network stack to return the network connection to an active state (step 308). Note that since this switch occurs quickly enough, and the system typically has capacity to buffer packets, there is effectively no interruption of network service. Relevant state information or other knowledge can be retained for the new function, or alternatively the new function may re-compute important parameters from scratch after the swap.

Fine-grained per-connection control of TCP behavior enables additional possibilities not available with a traditional hard-wired TCP layer. Traditionally, quality-of-service (QoS) and bandwidth control occur outside of the transport layer, for instance at the IP layer or in the network. While this approach is less intrusive to the network stack, it also has many limitations, e.g. providing end-to-end QoS in the network typically requires the configuration and cooperation of all of the switches and routers the traffic flows through, which is often infeasible. A plug-in function for a connection can provide a level of QoS and bandwidth control directly inside the TCP layer, thereby taking advantage of knowledge that is difficult to obtain from outside of the transport layer. For instance, in a traditional system, an attempt to throttle-down transmission might be interpreted as a sign of congestion and/or time-out, and prompt undesired re-transmission. The traditional approach of performing resource control and bandwidth management outside of the transport layer at a fine granularity also incurs heavy processing overhead in parsing headers and maintaining state on a per-flow basis. In the present invention, such capabilities can be added to the TCP behavior using a plug-in and handled appropriately.

The plug-in approach also enables employing an aggressive, special-purpose technique in a controlled network environment. For instance, a server in a data center with a well-controlled traffic pattern or well-tuned queuing model might deploy a non-compliant congestion control technique that allows packets to be sent without slow-start or any bandwidth throttling. This technique could be useful, for example, to eliminate the overhead of congestion control for connections that transfer data between two servers on a dedicated network link, or to expedite connections that exchange cluster membership heartbeat messages within the data center. Previously, such service variation either was not possible, or would require multiple servers.

Finally, per-connection tuning can also be used to deploy and test experimental TCP behaviors on a limited set of TCP connections on a production server without exposing other, normal operations on the server to the riskier new behavior.

In summary, the present invention extends TCP behavior using a plug-in architecture. This architecture allows TCP behavior to be tuned on a per-connection basis, thereby enabling the core functions of the TCP congestion control system to adapt to changing network conditions and improving the speed and efficiency of data transfers.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for dynamically changing the TCP behavior of a network connection, wherein the network connection allows communication between a first computer system and a second computer system, comprising:
receiving a request to change the TCP behavior for the network connection; and
changing a function associated with the TCP behavior for the network connection to a new function;
wherein changing the TCP behavior for the network connection allows network behavior to be tuned to the needs and environment of the network connection.

2. The method of claim 1,
wherein the network stack of the computer system includes a plug-in architecture that allows each network connection on the computer system to use a different function to control TCP behavior; and
wherein multiple functions for controlling TCP behavior can execute simultaneously on the computer system.

3. The method of claim 2,
wherein a function pointer is associated with each network connection; and
wherein changing the function associated with the TCP behavior for the network connection involves changing the function pointer to point to the new function.

4. The method of claim 3, wherein a vector of function pointers tracks the functions that determine the TCP behavior of every network connection in the computer system.

5. The method of claim 2, wherein the request to change the TCP behavior for the network connection is determined by:
a user;
an application;
an application type;
system policy;
the source and/or destination port numbers used by the network connection;
the source and/or destination Internet Protocol (IP) addresses of the network connection;
the protocol used by the network connection;
the characteristics of the network connection, including latency, bandwidth, loss-rate, and traffic characteristics;
the service provided by the network connection;
cached path characteristics from past connections; and/or the location of the computer system and the second computer system.

6. The method of claim 1,
wherein the computer system maintains a list of candidate functions for TCP behavior; and
wherein the method further comprises allowing an application or user to choose the new function from the list of candidate functions.

7. The method of claim 1, wherein the TCP behavior of the new function does not comply with the TCP standard.

8. The method of claim 7,
wherein the new function does not implement congestion control; and
wherein this non-compliant TCP behavior can be used to optimize data transfer between the computer system and the second computer system in some environments.

9. The method of claim 3, wherein changing the function associated with the TCP behavior further involves:
disabling a portion of the network stack to put the network connection into a quiescent state;
changing the function pointer to point to the new function; and
re-enabling the portion of the network stack to return the network connection to an active state.

10. A computer-readable storage medium storing instructions that when executed by a computer cause the computer to perform a method for dynamically changing the TCP behavior of a network connection, wherein the network connection allows communication between a first computer system and a second computer system, the method comprising:
receiving a request to change the TCP behavior for the network connection; and
changing a function associated with the TCP behavior for the network connection to a new function;
wherein changing the TCP behavior for the network connection allows network behavior to be tuned to the needs and environment of the network connection.

11. The computer-readable storage medium of claim 10,
wherein the network stack of the computer system includes a plug-in architecture that allows each network connection on the computer system to use a different function to control TCP behavior; and
wherein multiple functions for controlling TCP behavior can execute simultaneously on the computer system.

12. The computer-readable storage medium of claim 11,
wherein a function pointer is associated with each network connection; and
wherein changing the function associated with the TCP behavior for the network connection involves changing, the function pointer to point to the new function

13. The computer-readable storage medium of claim 12, wherein a vector of function pointers tracks the functions that determine the TCP behavior of every network connection in the computer system.

14. The computer-readable storage medium of claim 11, wherein the request to change the TCP behavior for the network connection is determined by:
a user;
an application;
an application type;
system policy;
the source and/or destination port numbers used by the network connection;
the source and/or destination Internet Protocol (IP) addresses of the network connection;
the protocol used by the network connection;
the characteristics of the network connection, including latency, bandwidth, loss-rate, and traffic characteristics;
the service provided by the network connection;
cached path characteristics from past connections; and/or
the location of the computer system and the second computer system.

15. The computer-readable storage medium of claim 10,
wherein the computer system maintains a list of candidate functions for TCP behavior; and
wherein the method further comprises allowing an application or user to choose the new function from the list of candidate functions.

16. The computer-readable storage medium of claim 10, wherein the TCP behavior of the new function does not comply with the TCP standard.

17. The computer-readable storage medium of claim 16,
wherein the new function does not implement congestion control; and
wherein this non-compliant TCP behavior can be used to optimize data transfer between the computer system and the second computer system in some environments

18. The computer-readable storage medium of claim 12, wherein changing the function associated with the TCP behavior further involves:
disabling a portion of the network stack to put the network connection into a quiescent state;
changing the function pointer to point to the new function;
re-enabling the portion of the network stack to return the network connection to an active state.

19. An apparatus for dynamically changing the TCP behavior of a network connection, wherein the network connection allows communication between a first computer system and a second computer system, comprising:
a receiving mechanism configured to receive a request to change the TCP behavior for the network connection; and
a change mechanism configured to change a function associated with the TCP behavior for the network connection to a new function;
wherein changing the TCP behavior for the network connection allows network behavior to be tuned to the needs and environment of the network connection

20. The apparatus of claim 19,
wherein the network stack of the computer system includes a plug-in architecture that allows each network connection on the computer system to use a different function to control TCP behavior; and
wherein multiple functions for controlling TCP behavior can execute simultaneously on the computer system.
